(19) United States
(12) Patent Application Publication
(10) Pub. No.: US 2011/0177602 A1
(43) Pub. Date: Jul. 21, 2011

(54) Composite Structure

(75) Inventors: Dietmar Appelhans, Dresden (DE); Mathias Lakatos, Dresden (DE); Wolfgang Pompe, Hartha (DE)

(73) Assignee: Endress + Hauser Conducts Gesellschaft furMess-und Regeltechnik mbH +Co. KG, Gerlingen (DE)

(21) Appl. No.: 13/000,385

(22) PCT Filed: Jun. 24, 2009
(86) PCT No.: PCT/EP2009/057909

§ 371 Date: Mar. 31, 2011

(30) Foreign Application Priority Data
Jun. 27, 2008 (DE) 10 2008 030 910.9
Jun. 27, 2008 (EP) PCT EP2008 058288

(51) Int. Cl. G01N 31/22; B82Y 15/00

(52) U.S. Cl. 436/17; 977/773; 977/920; 977/902; 977/834; 977/810; 977/774; 977/788; 977/811; 977/838

(57) ABSTRACT

A composite structure, for marking biomolecules in a biological, biochemical or medicinal system, comprises: at least one nano particle and at least one dendritic macromolecule, which has an inner region with branched, especially perfectly branched to highly branched, structures and a periphery, which comprises surface groups of the dendritic macromolecule, wherein a plurality, especially more than 50%, of the surface groups have in the periphery of the dendritic macromolecule, in each case, at least one functional group of first type, wherein the functional group of first type comprises at least one monosaccharide-, oligosaccharide- and/or polysaccharide unit, and wherein the dendritic macromolecule stabilizes the nano particle.

The invention relates to a composite structure, comprising at least one nano particle and at least one dendritic macromolecule, which stabilizes the nano particle. Such a composite structure can find application in biochemistry or biophysics, especially in biotechnology and in biosensors.

Markers are applied in biochemistry, biophysics, medicine and bioprocess technology, for example, for the following purposes:
For determining the affinity of two biomolecules, up to and including the quantitative determining of the complex formation constants;
For spatial and/or time observation of transport phenomena, for example, of bioactive molecules, in cells, especially also for diagnostic and therapeutic applications;
For detection and/or determining of concentration of an analyte in a sample by means of a biosensor on the basis of an affine interaction, e.g. antibody/antigen or DNA single strand/thereto complementary DNA sequence, by means of established assay-methods;
For investigation, or detection, of protein/protein interactions.

When, in the following, biomolecules are discussed, molecules are meant, which play a role in biological, biochemical or biophysical systems, for example, a ligand or a receptor in a ligand/receptor-system, a bioactive molecule, a bioactive macromolecule, a biological recognition sequence, especially an oligo- or polynucleotide or a peptide recognition sequence.

Need exists in all these applications for long lived, chemically robust markers. Used as markers are, for example, luminescent markers, especially fluorescent markers, or magnetic markers. By means of locationally resolved detection of the marked biomolecules, for example, the spatial distribution of marked biomolecules, e.g. in cells, can be determined. By measuring the intensity of the marker response, for example, of radiated fluorescent light, or a magnetic field relaxation in the case of magnetic markers, the concentration of marked biomolecules can be ascertained. Luminescent markers play an important role, for example, in biosensors, for example, in the known EIA/ELISA assay method. Magnetic markers are applied, for example, in magnetic relaxation, immunoassays (MARIA).

Markers with luminescent properties, so-called luminescent markers, should preferably be capable of being excited often and/or durably. They should, as well, be chemically, as well as photochemically, robust. Conventional fluorescent markers comprise, for example, aromatics, heterocyclics or modified fluorescing DNA bases. Such organic molecules degrade after a series of optical excitings or after a longer lasting optical exciting, so that a sufficient photochemical stability is not assured. This effect is also known under the term “photobleaching”.

In the field of biosensors, it is additionally advantageous, when the marking remains stable over an as broad as possible range of environmental variables, for example, over a broad pH-value- and temperature range. In the case of the observation of transport phenomena in cells, biocompatibility of the marker plays an important role.

In EP 1 473 347 B1, inorganic fluorescing core-jacket-nano particles and their application as markers in a bioassay method, especially, respectively, in a FRET (Fluorescence-Resonance Energy Transfer)-, or RET(Resonance Energy Transfer)-assay method, are described. These luminescent nano particles comprise a core of a first metal salt or metal oxide, which is surrounded by a shell of a second metal salt, which is luminescent and has non-semiconductor-properties. Such fluorescing inorganic nano particles should have a higher photochemical stability than, for example, organic, fluorescent dyes, such as fluorescein or rhodamine. The synthesis of such particles is, however, relatively complex. Furthermore, in order to attach the inorganic core, jacket, nano particles to biomolecules as markers, a functionalizing of their surface is required, which, as a rule, means a number of additional synthesis steps.

In DE 10 2008 016 712 A1, nano particles are described, which have a core particle of metal and a cladding of a diamine block polymer, as well as their application in a biochemical, chemical or biological method, for example, for marking antibodies or nucleic acids or as a carrier of enzymes attached thereto. These particles should be stable especially against aggregation and therewith storable for long periods of time, relatively temperature resistant and easily modifiable. The stabilizing of the nano particles is attributed to the polyethylene oxide group present in the middle of the polymer chain of the diamine block polymer. The terminal NH₂ groups of the diamine block polymer can be used, after forming the nano particle, to attach proteins or nucleic acids covalently to the nano particles.

A disadvantage of these nano particles is that the ligand cladding formed from diamine block polymers is still relatively open and flexible and so offers, in uncontrollable manner, non-covalent interactions with the metal core or the ligand cladding, a fact which facilitates the coupling of the individual metal cores present within the ligand cladding.

From Zheng J., Fluorescent Noble Metal Nanoclusters, Dissertation, Georgia Institute of Technology, April 2005, composite structures of gold- or silver nano particles embedded in dendrimers are known. Described there are, for example, OH-terminated polyamidoamines (PAMAM) of second to fourth generation, into which gold nano particles are embedded. These have fluorescing properties. These composite structures are produced by reduction of HAuCl₄·5H₂O by means of NaBH₄ in the presence of PAMAM in aqueous solution or in methanol. The dendrimer controls here both the nucleation as well as also the size of the metal nano particles by inhibiting their growth, especially by suppressing Ostwald maturation.

It has, however, been found that these structures, as in the case of the earlier described ligand claddings, are still too open and flexible to protect the embedded metal nano particles sufficiently over long time periods as regards aggregation and chemical attack.

It is therefore an object of the invention to provide nano particles, especially nano particles for marking in biochemical systems, wherein the nano particles overcome the disadvantages of the state of the art. Especially, nano particle markers should be provided, which are chemically robust, remain stable in the face of a high number and/or long duration of excitations, especially fluorescent excitations, and have, in such case, preferably high biocompatibility and good functionalizing capability.

This object is achieved by a composite structure, comprising:

At least one nano particle, especially a nano particle with luminescent properties or magnetic properties,
and at least one dendritic macromolecule, which has an inner region with branched, especially highly branched, to perfectly branched, structures, and a periphery, which comprises surface groups of the dendritic macromolecule, characterized in that
a plurality, especially more than 50%, of the surface groups in the periphery of the dendritic macromolecules have, in each case, at least one functional group of first type, wherein the functional group of first type comprises at least one monosaccharide-, oligosaccharide- and/or polysaccharide unit,
wherein the dendritic macromolecule stabilizes the nano particle.

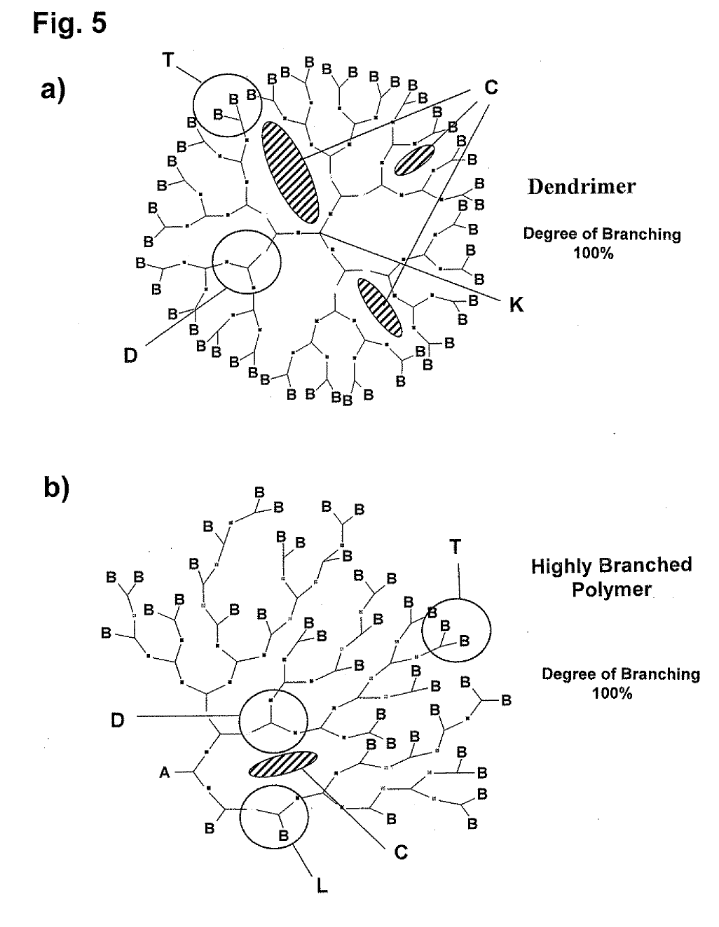

The terminology, dendritic macromolecule, includes, besides highly branched (also: hyperbranched) polymers, also dendrimers as representatives of the perfectly branched macromolecules. Other details are presented in the review articles of Voit (Acta Polymer, 1995, 46, Pgs. 87-99), Tomalia (Angew. Chem., 1990, 102, Pgs. 119-157) and Voegtle (Prog. Polym. Sci., 2000, 25, Pgs. 987-1041) concerning the structure of dendritic polymers, or dendritic macromolecules, wherein dendrimers have spherical molecular shapes and highly branched polymers of rather globular, or more open, molecule structures. FIG. 5 shows characteristic structural units of dendrimers and highly branched polymers.

FIG. 5 a) shows a perfectly branched dendrimer with a branching nucleus K. Extending from the branching nucleus K are branched, dendritic units D in the manner of a tree structure, to which, in turn, other dendritic units D connect. Thus, the terminology, perfectly branched, dendrimer structure, means a structure, in the case of which all branchings are used, i.e. the degree of branching is 100%. The number of levels of dendritic units D is referred to as the “generation” of the dendrimer. The periphery of the dendrimer is formed by terminal units T, to which no additional branching units D connect. In the example of FIG. 5 a), the terminal units T have, in each case, two surface groups B. This surface groups B form, thus, end groups on a branching group of the dendrimer and lead to no additional branching. In the inner region of the dendrimer, in intermediate spaces of the perfectly branched structure, are to be found cavities C, which are referred to as dendritic cages.

FIG. 5 b) shows a highly branched, dendritic polymer. Proceeding from a focal group A, dendritic units D spread out as branching units, wherein not every branching location is utilized. The degree of branching of a highly branched, dendritic polymer lies, thus, under 100%, frequently between 40 and 70%. One speaks in the case of such structures as highly branched structures. As in the case of the dendrimer illustrated in FIG. 5 a), also here there are cavities C in the inner region of the highly branched, dendritic polymer, within its highly branched structure. The periphery of the highly branched, dendritic polymer is formed by terminal units T, which bear one or a number of end groups B, and by linear units L, which bear one or a number of end groups B. In contrast with the terminal units T, to which no additional branching units D connect, while the linear units have, indeed, likewise one or a number of end groups B, which lead to no additional branching, they are, however, connected via at least one bond with additional branching units D, which form no end group B, but, instead contribute to the branched structure. A part of the end groups B of the linear units L can, consequently, be present in the inner region of the highly branched, dendritic polymer, while a further part of the end groups B of the linear units L can be present in the periphery as surface groups of the highly branched, dendritic polymer.

The surface groups of the dendritic macromolecules, especially of a dendrimer or of a highly branched, dendritic polymer, can, in turn, comprise one or a number of functional groups. A functional group can basically be formed from an atom or a group of atoms.

According to the invention, a plurality of the surface groups of the dendritic macromolecules comprise, in each case, at least one functional group of first type, wherein the functional group of first type has at least one monosaccharide-, oligosaccharide- and/or polysaccharide unit. The term, oligosaccharide, means a carbohydrate, which is constructed of a plurality of same or different monosaccharides, which are connected with one another by glycosidic bonds. Corresponding to the number of present monosaccharide units, one speaks of di-, tri-, tetra-, penta-, etc., saccharides, which can be both linear (unbranched), as well as also branched. The distinction between oligo- and polysaccharides is fluid and depends on whether a defined structure with determined molecular weight is present (oligosaccharide), or only a statistical distribution of the molecule sizes is to be ascertained (polysaccharide). The functional group of first type can have other groups in addition to the mono-, oligo- and/or polysaccharide unit. The plurality of surface groups, which have a functional group of first type, can comprise especially monosaccharide-, oligosaccharide- or polysaccharide groups or functional groups formed from a derivative of a monosaccharide, an oligosaccharide or a polysaccharide.

The nano particle of the described composite structure forms the component serving for the actual marking, i.e. the nano particle possesses detectable properties, especially luminescent properties or magnetic properties. Luminescence designates the property of the nano particles to absorb energy (e.g. in the form of light of the IR-, VIS- or UV-spectrum), which then is radiated back as light of lower energy. The at least one dendritic macromolecule, which possesses a plurality of surface groups, which comprise at least one functional group of first type, which has at least one mono-, oligo- or polysaccharide unit, serves in the composite structure for stabilizing the nano particle. The structural unit the composite structure formed from the dendritic macromolecule and its functional groups is referred to in the following by the shortened expression, “saccharide functionalized, dendritic macromolecule”, or, so far as the dendritic macromolecule involves a highly branched polymer, or a dendrimer, respectively, as “saccharide functionalized, highly branched polymer”, or as “saccharide functionalized dendrimer”.

The shape of the nano particle can be e.g. needle shaped, ellipsoidal or ball shaped, wherein the latter two options are preferable. The nano particles have preferably a size of 0.5 to 20 nm measured along their longest axis. A size of 0.5 to 10 nm or 0.5 to 5 nm or even 0.5 to 2 nm is yet more advantageous.

Since a plurality, especially at least 50%, of the surface groups of the dendritic macromolecules have at least one functional group with a mono-, oligo- or polysaccharide unit, these functional groups of first type form a tightly packed “saccharide cladding” around the dendritic macromolecule. The so formed structural unit of the composite structure is so tightly packed and rigid, that aggregation of the nano particles is effectively prevented and also interaction of the nano particles with chemical substances in the environment is lessened. An example is a polyamine based dendrimer, whose surface groups comprise up to 50% of at least one mono-, oligo- or polysaccharide group. For this, for example, each terminal unit can have a first surface group, which includes a mono-, oligo- or polysaccharide group, wherein the second surface group of the terminal amine unit can be formed e.g. by a hydrogen atom.

At the same time, the saccharide cladding offers the advantage of high biocompatibility of the total composite structure, especially in comparison to a “free” nano particle without the stabilizing saccharide functionalized, dendritic macromolecule. Moreover, individual or a plurality of groups of the saccharide cladding are easily functionalizable, i.e., with little effort and with known methods of saccharide chemistry, a large number of different functional groups of second type can bond to the functional mono-, oligo- or polysaccharide groups, in order, via these functional groups of second type, to connect other molecules, especially biomolecules, with the composite structure. Also the present hydroxide groups of the mono-, oligo-, or polysaccharide groups can serve as functional groups of second type to link to other molecules, especially biomolecules.

The nano particle can have luminescent properties. A luminescing nano particle can comprise one or more metals, especially noble metals; for example, the nano particles can be of gold, silver or copper or a mixture of at least two of these metals. Also, a fluorescing nano diamond is an option here as nano particle. Luminescing nano particles can also be so-called quantum dots (quantum dots). In such case, these involves semiconductor nano particles, especially II-VI- or III-V semiconductors, which can be doped, and which are characterized by quantum confinement both of electrons as well as also of holes in all three spatial directions. Such nano particles are suited, for example, for applications as luminescent markers in an assay based on optical transduction.

The nano particles can supplementally or alternatively also have magnetic properties. A magnetic nano particle can, for example, comprise one or more metals from the group iron, cobalt, nickel or a metal oxide, wherein the metal oxide can be selected especially from the group formed from iron oxide, especially magnetite Fe₃O₄ or y-Fe₂O₃, barium ferrite, strontium ferrite, chromium dioxide and iron oxides with manganese-, copper-, nickel- or cobalt additions. The magnetic nano particles can be used for marking biomolecules, for example, in a magnetic assay, i.e. an assay, which is based on a magnetic transduction principle.

Luminescing metal nano particles have advantageously an expanse along their longest axis of less than 2 nm, especially between 0.5 and 1.5 nm.

Magnetic metal- or metal oxide, nano particles have advantageously an expanse along their longest axis between 0.5 and 50 nm, preferably between 0.5 and 20 nm, or even between 0.5 and 10 nm.

In an advantageous further development, the nano particle has on its surface a plurality of molecules of a dispersion stabilizer bonded to the surface to form a cladding around the nano particle. The dispersion stabilizer can be, especially, an n-alkanethiol, a thiol- and/or amine functionalized phenol, or a carboxyl functionalized alkanethiol, for example, octadecanethiol, aminothio phenol or mercaptoundecanoic acid or a derivative of octadecanethiol, aminothio phenol or mercaptoundecanoic acid. These dispersion stabilizers are especially well suited for stabilizing metal nano particles in their synthesis in organic or aqueous solution. Non-covalent interactions between the free end groups of the dispersion stabilizer-molecules and the dendritic macromolecule provide an essential contribution for stabilizing the nano particle by means of the saccharide functionalized, dendritic polymer.

Especially advantageous has proved to be use of a dendrimer, especially a third to tenth generation one, as a dendritic macromolecule in the above described composite structure, as selected from the group composed of polypropylene imines (PPI), polyamidoamines (PAMAM) and polyether imines (PEI) and their derivatives.

In an alternative embodiment, serving as dendritic macromolecule is a highly branched polymer, preferably one with an average molecular weight of less than 10,000 g/mol, serve, which is selected from the group preferably composed of highly branched poly(ethylene imines), highly branched polyglycerols, highly branched polyamides, highly branched polylysines, highly branched polyesters and their derivatives.

The functional group of first type can be a monosaccharide group, a linear or branched oligosaccharide group, a linear or branched polysaccharide group, a group formed from a derivative of a monosaccharide, a group formed from a derivative of a linear or branched oligosaccharide or a group formed from a derivative of a linear or branched polysaccharide.

In such case, preferably glucose-, fructose-, galactose-, maltose-, lactose-, cellobiose-, mannose-, dimannose-, melobiose-, maltotriose- and/or maltoheptaose groups and/or groups formed from derivatives of these can be used.

In a special embodiment of the dendritic macromolecules as dendrimer, a plurality, especially more than 50%, of the terminal units present in the periphery comprise one, two or more functional groups of first type.

Fundamentally, there are two options for stabilizing the nano particle by the saccharide functionalized, dendritic macromolecule. The first option is that the fluorescing nano particle is accommodated in the inner region of the dendritic macromolecules, in a cavity, also referred to as a dendritic cage or dendritic box.

The second option is that at least two saccharide functionalized, dendritic macromolecule units adjoin with their peripheries to the nano particle and stabilize it through interactions, especially non-covalent interactions, such as e.g. van der Waals interactions, with the ligand cladding of the nano particle formed by the above mentioned dispersion stabilizer.

The above described composite structure is distinguished by an easy functionalizing capability with known methods from the field of sugar chemistry. This can be utilized, to attach the composite structure to a biomolecule. It is, in this regard, especially advantageous, when at least one surface group of the dendritic macromolecule and/or at least one functional group of first type belonging to a surface group of the dendritic macromolecule includes a functional group of second type, which is especially suitable to react with a biomolecule, especially a ligand or a receptor of a ligand/receptor-system, a bioactive molecule, a bioactive macromolecule, a biological recognition sequence, especially an oligo- or polynucleotide, or a peptide recognition sequence,

The functional group of second type can form, for example, a surface group bonded to a terminal unit or to a linear unit of the dendritic macromolecule. The functional group of second type can also be bonded to a surface group comprising a functional group of first type, for example, to an functional mono-, oligo- or polysaccharide group bonded to a terminal or linear unit.

A ligand/receptor system is composed, for example, of two molecules, namely a ligand and a receptor, which specifically attach to one another. Such systems are applied in biosensors, in order to detect an analyte in a sample. In such case, for example, the ligand forms the analyte of the system, which is bonded to a receptor specifically attaching to the ligand.

The bonding of the composite structure to a biomolecule can be produced by bonding to a surface group of the dendritic macromolecule or to a functional group of first type, especially a mono-, oligo- or polysaccharide group, one or more functional groups of second type, which are capable of bonding to a biomolecule. The biomolecule can correspondingly have a functional group of third type, which preferably bonds to the functional group of second type of the composite structure. For example, the functional group of second type can be a streptavidin group, while the biomolecule has, correspondingly, a biotin group. This will lead, in general to the fact that the bonding between composite structure and biomolecule is formed preferably via a biotin to streptavidin connection.

The term “functional group” is, in this regard, not limited to reactive groups, which form covalent bonds with the, in given cases, functionalized biomolecule, but, instead includes also chemical groups, which lead to a non-covalent interaction, e.g. an ionic interaction or a hydrogen bridge bonding, with the one or more biomolecules. It is possible, that the bonding of the composite structure occurs via surface groups of the dendritic macromolecule present in any event and via functional groups of the biomolecule present from the outset. It is also possible first to functionalize the surface groups of the macromolecule and/or the biomolecule, in order to produce the corresponding bonding.

Thus, the functional groups of first type comprising hydroxide groups of the mono-, oligo- or polysaccharide units can serve as functional groups for bonding to a functional group of the biomolecule. The bonding of the composite structure can occur, furthermore, also via an enzymatic reaction between a mono-, oligo- or polysaccharide group bonded to the dendritic macromolecule and the biomolecule.

To the extent that the functional group of second type is bonded directly to a surface group of the dendritic macromolecule, it can be, for example, an amino group, an acid group, an epoxide group, an azide group, an alkyne group, an alkylene group, an activated ester group, an aldehyde group, an amide derivative group, a sulfonic acid amide derivative group, a sulfate group, a sulfonate group, a halogen group, an activated ether group or a thiol group.

To the extent that the functional group of second type is bonded to a functional group of first type, it can be, for example, a hydroxy group, an amino group, an acid group, an epoxide group, an azide group, an alkyne group, an alkylene group, an activated ester group, an aldehyde group, an amide derivative group, a sulfonic acid amide derivative group, a sulfate group, a sulfonate group, a halogen group, an activated ether group or a thiol group.

The functional group of third type, thus the functional group bonded to the biomolecule, is so selected, that it preferably bonds with the present functional group of second type. Considered thus as functional group of third type is an amino group, an acid group, an epoxide group, an azide group, an alkyne group, an alkylene group, an activated ester group, an aldehyde group, an amide derivative group, a sulfonic acid amide derivative group, a sulfate group, a sulfonate group, a halogen group, an activated ether group or a thiol group.

In a method for the manufacture of the described composite structure, nano particles stabilized with a dispersion stabilizer, especially nano particles having a diameter of less than 10 nm, preferably between 0.8 and 2 nm, are dispersed in an aqueous solution of dendritic macromolecules, wherein the dendritic macromolecules have an inner region with branched, especially perfectly branched to highly branched, structures and a periphery, which comprises surface groups of the dendritic macromolecules, wherein a plurality of the surface groups of the dendritic macromolecules have, in each case, at least one functional group of first type, wherein the functional group of first type comprises at least one mono-, oligo- or polysaccharide unit.

Used as dispersion stabilizer can be an n-alkanethiol, a thiol- and/or amine functionalized phenol, or a carboxyl functionalized alkanethiol, for example, octadecanethiol, aminothio phenol or mercaptoundecanoic acid or a derivative of octadecanethiol, aminothio phenol or mercaptoundecanoic acid.

The described composite structures can be used for marking biomolecules in a biological, biochemical, biophysical or medicinal method, especially in the field of biosensors, in competitive or non competitive assays, especially assays based on an optical or magnetic transduction principle.

The invention will now be explained in greater detail on the basis of the drawing, the figures of which show as follows:

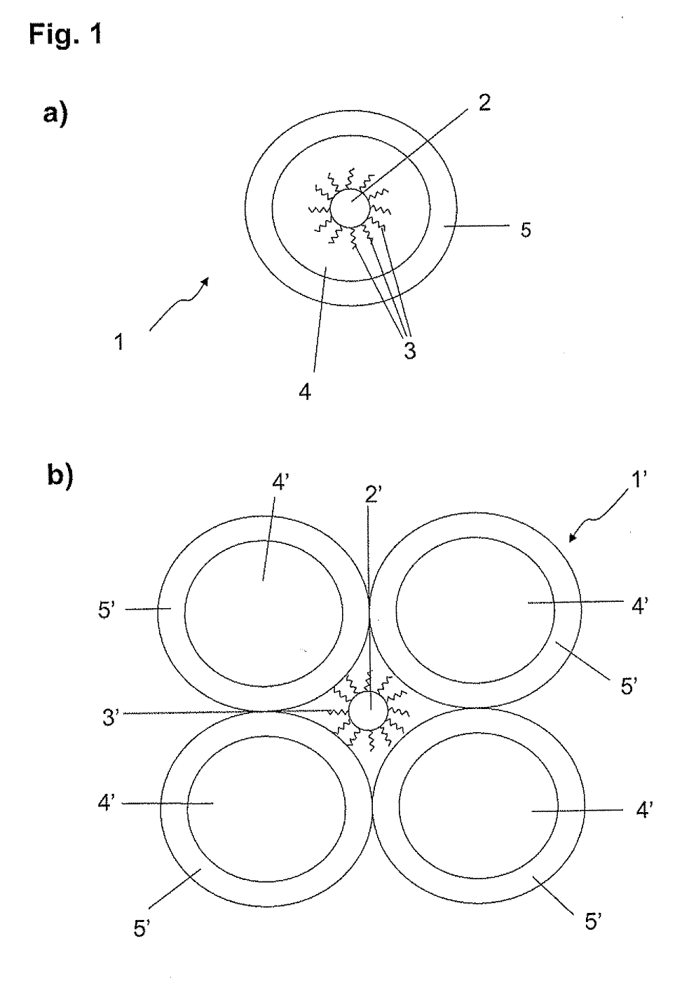

FIG. 1 schematic representations of the composite structure:
a) a first variant, in the case of which the nano particle is arranged in a cavity in the inner region of a dendritic macromolecule; and
b) a second variant, in the case of which the nano particle is surrounded by a plurality of saccharide functionalized, dendritic macromolecules and so is stabilized;

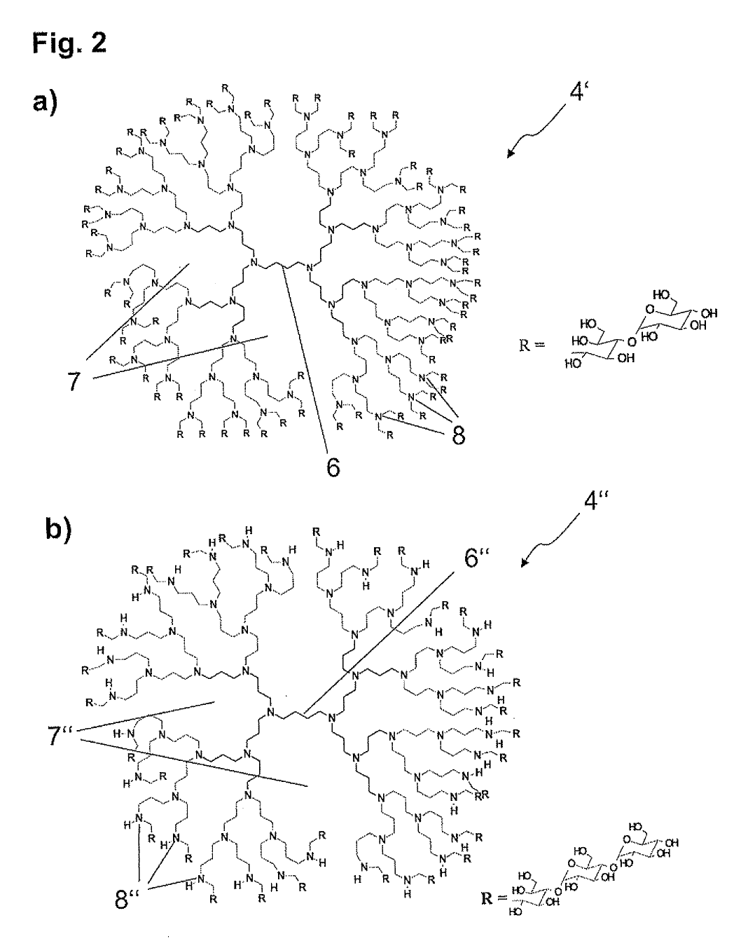

FIG. 2 a) a structural formula of a first saccharide functionalized dendrimer; and
b) a structural formula of a second saccharide functionalized dendrimer;

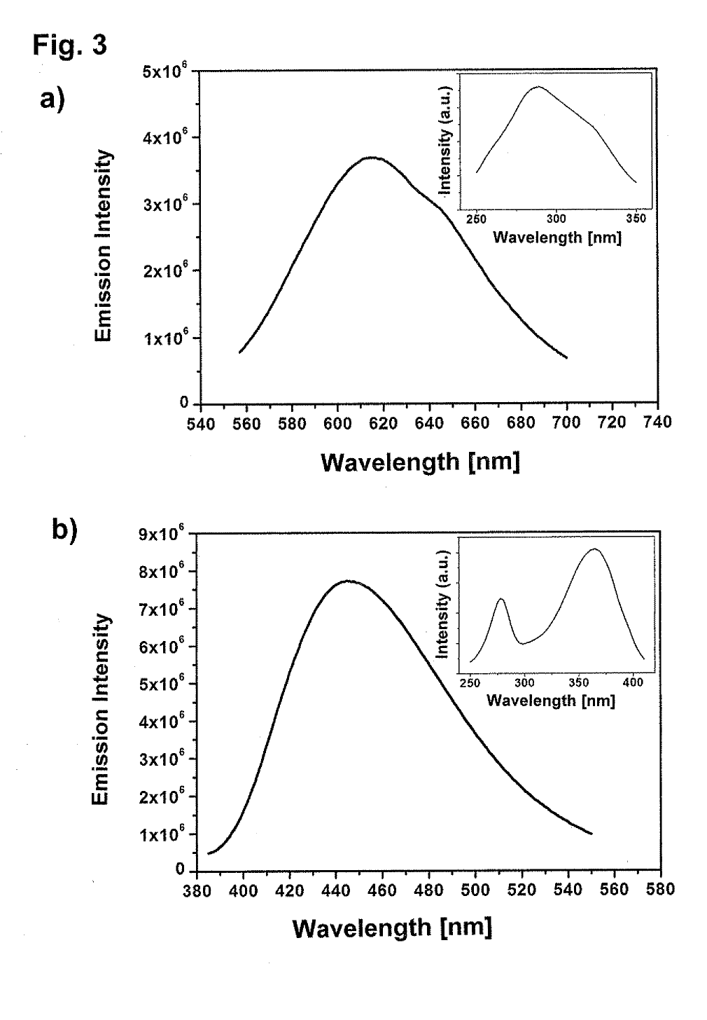

FIG. 3 fluorescence spectra of
a) yellow/reddish fluorescing, gold nano particles for a composite structure, and
b) blue fluorescing, gold nano particles for a composite structure

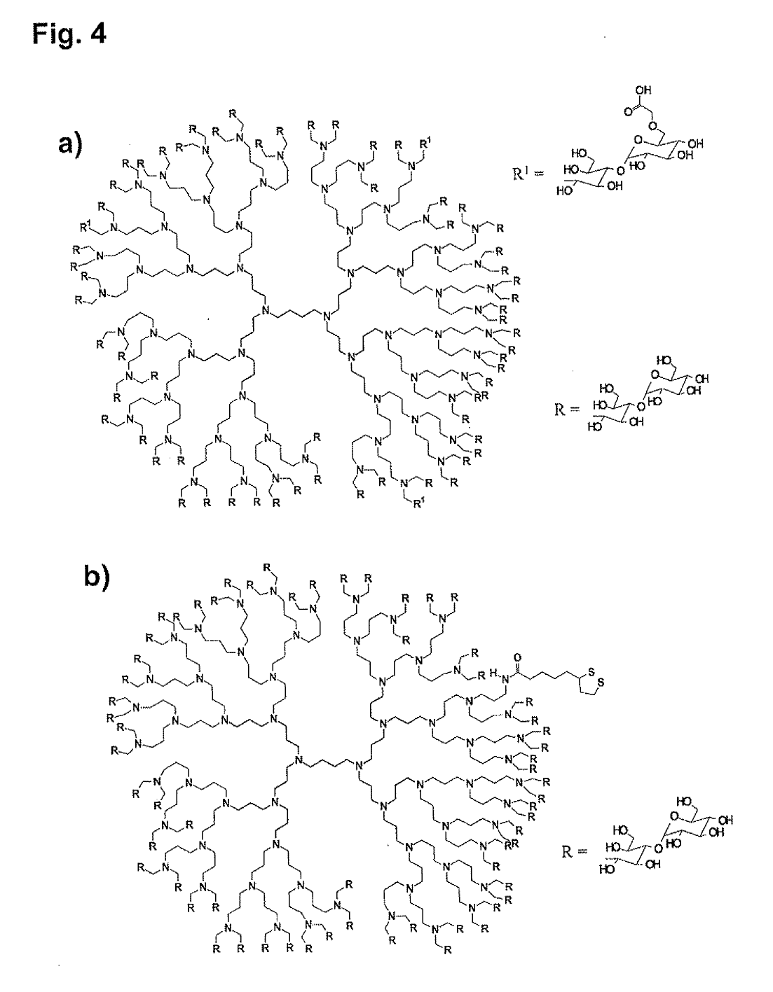

FIG. 4 a) a structural formula of a first saccharide functionalized dendrimer having an additional functional group of second type on a saccharide-unit for bonding to a biomolecule; and
b) a structural formula of a second saccharide functionalized dendrimer having an additional functional group of second type on an end group of the dendrimer for bonding to a biomolecule; and

FIG. 5 a) the structure A of a dendrimer; and
b) the structure B of a highly branched polymer.

FIG. 1 a) shows a schematic representation of the composite structure 1 in a first variant, in the case of which the nano particle 2 is arranged in a cavity in the inner region of the dendritic macromolecule 4, on whose periphery a plurality of functional mono-, oligo- or polysaccharide groups are present, which form a saccharide cladding 5. Such a composite structure 1 can comprise, for example, as nano particle 2, a gold nano particle having a diameter (measured along its longest axis) of 0.5 to 2 nm and, as dendritic macromolecule 4, a PPI-dendrimer of fourth generation, whose terminal amine units have, in each case, two surface groups. The nano particle 2 is surrounded with a dispersion stabilizer cladding 3, in the case of the present example of a gold nano particle, for example, of n-alkanethiol molecules. N-alkanethiols can, as described below in greater detail, be used as dispersion stabilizer in the synthesis of the gold nano particles. Due to the hydrophobic properties of the inner region of the PPI dendrimer, the nano particles 2 with their dispersion stabilizer cladding 3 can be accommodated and stabilized within a cavity of the branched structure of the dendrimer 4.

FIG. 2 a) shows a saccharide functionalized PPI dendrimer 4″ of fourth generation, which can be used, for example, in a composite structure according to FIG. 1 a) as the gold nano particle 2 stabilizing, dendritic macromolecule. The PPI dendrimer 4″ has a branching nucleus 6″, from which repetitive units extend. Each nitrogen atom serves as a branching location, from which, in each case, two new “branches” extend. In this way, there results an essentially spherical shape of the PPI dendrimer 4″. Within the so formed spheres lie cavities 7″, in which a nano particle 2 (not shown in FIG. 2 a)) surrounded by a dispersion stabilizer cladding 3, e.g. a gold nano particle with an n-alkanethiol cladding, accommodated and stabilized. Bonded to the terminal units 8″ of the dendrimer 4″ can be, in each case, two surface groups, each of which comprises a functional group R. In the example of FIG. 2 a), the functional groups R are maltose groups, thus di-saccharide groups. Since each terminal unit 8″ has two di-saccharide groups, there results a tightly packed, oligosaccharide cladding around the dendrimer 4″. This leads to an increased rigidity of the total molecule. In this way, interactions between the nano particles 2 accommodated in a cavity 7″ with the chemical environment present outside the composite structure 1, or with other nano particles 2, in given cases, likewise retained in such a composite structure 1 are made difficult or suppressed, which contributes to a stabilizing of the nano particles 2.

FIG. 1 b) shows another variant of the composite structure 1′, in the case of which the nano particle 2′ with its dispersion stabilizer cladding 3′ is stabilized by a plurality of saccharide functionalized, dendritic macromolecules, which surround it spatially. An example of such a composite structure 1′ comprises a gold nano particle, which is surrounded by a cladding of n-alkanethiol molecules, which, in each case, possess a terminal acid group, for example, an ω-mercapto-alkane acid. As dendrimer 4′ serves for this example, in turn, the PPI dendrimer 4″ of fourth generation shown in FIG. 2 a) with terminal units 8″ doubly functionalized by maltose groups, whereby a di-saccharide cladding 5′ is formed. The acid groups of the ω-mercapto-alkane acid molecules can interact both with nitrogen atoms of the branched structure of the PPI dendrimer in its inner region as well as also with nitrogen atoms on the periphery of the PPI dendrimer. In the latter case, a composite structure 1′ forms, in the case of which the nano particle 2′ is surrounded and shielded by a plurality of saccharide functionalized dendrimers 4′. In this way, the nano particle 2′ is likewise effectively shielded from the chemical environment, so that both interactions with additional nano particles 2′, especially Ostwald maturation, as well as also chemical influencing by ions or molecules located in solution are effectively made difficult or suppressed.

FIG. 2 b) shows a further example of a saccharide functionalized dendrimer 4′″ suited for forming a composite structure with a nano particle, especially a gold nano particle. This is a PPI dendrimer with a branching nucleus 6′″ and therefrom emanating amine branching units. The terminal units 8′″ of the PPI dendrimer have, in this case, each two surface groups, wherein the one surface group has, in each case, only a hydrogen atom, while the other surface group is an oligosaccharide unit R, wherein the oligosaccharide unit R in the present example is a maltotriose group. Due to the greater space requirement of the maltotriose in comparison to the maltose of the example illustrated in FIG. 2 a), there is, in spite of this simple functionalizing of the terminal units 8′″, a sufficient state of sealing and stiffness of the saccharide functionalized dendrimer 4′″ for stabilizing a nano particle (not shown in FIG. 2 b)) in the inner region of the dendrimer 4″, especially within a cavity 7′″.

Instead of the described functional maltose-, or maltotriose, groups and their derivatives, also other functional groups, which have mono- or oligosaccharide units, are suitable for functionalizing the dendrimer 4, 4′, 4″, 4′″, especially functional groups such as glucose, fructose, galactose, maltose, lactose, cellobiose, mannose, dimannose, melobiose or maltoheptaose, as well as derivatives of these. Furthermore, the dendrimer 4, 4′, 4″, 4′″ can be functionalized with various mono- or oligosaccharide groups, especially with combinations of the earlier named mono- and oligosaccharide groups.

Manufacture of the described composite structures is explained in the following on the basis of two synthesis examples in organic and aqueous solution for fluorescing, gold nano particles.

The manufacture of fluorescing gold nano particles in an organic medium can occur, for example, according to a method described in Zheng J., Fluorescent Noble Metal Nanoclusters, Dissertation, Georgia Institute of Technology, April 2005. In such case, 0.5 μmol of gold tetrachloric acid HAuCl₄·H₂O and 0.25 μmol octadecanethiol are mixed into 2 ml solution composed of 90% chloroform and 10% ethanol. The reduction of the HAuCl₄·H₂O for forming colloidal nano particles occurs by addition of sodium boron hydride NaBH₄ at room temperature. For a largely complete reaction yield, the solution is then allowed to stand for one day. The so formed gold nano particles have along their longest axis a diameter of 1 to 1.5 nm and exhibit yellow/reddish fluorescence. In the case of application of aminothio phenol instead of octadecanethiol as dispersion stabilizer, blue fluorescing gold nano particles with a diameter along their longest axis of less than 1 nm are obtained. The measured fluorescence signals for the gold nano particles synthesized as described are presented in FIG. 3 a) for the yellow/reddish fluorescing, nano particles and in FIG. 3 b) for the blue fluorescing, nano particles. In the right upper corner of each chart, the corresponding extinction spectrum of the nano particles is presented.

The so obtained thiol stabilized, nano particles can with the assistance of the dendrimer-structures described on the basis of FIGS. 2 a) and b) be transferred into an aqueous solution and stabilized therein. For this, the gold nano particles with their octadecanethiol-, or aminothio phenol cladding are first separated from the organic solvent by a centrifuging step. The centrifuging occurs preferably over, for instance, 30 min at 25,000 g. The sediment is suspended in an aqueous solution having a dendrimer content of 0.1 wt.-%. In the present example, a solution of saccharide functionalized PPI dendrimer of fourth generation, e.g. according to FIG. 2 a), with maltose groups as functional saccharide groups, was used. The ratio of the concentration of dendrimer to nano particles (in mol/l) is selected in the range of 0.7 to 1.7. The gold nano particles are, due to the described non-covalent interaction between their octadecanethiol-, or aminothio phenol cladding and the nitrogen atoms present in the inner region of the dendrimers, accommodated within the cavities in the dendrimer structure and stabilized there. The fluorescence signals (compare FIGS. 3 a) and b)) of the nano particles remain stable even after forming the composite structure of nano particles and stabilizing, saccharide functionalized, PPI dendrimer, especially there is no shifting of the signals to higher or lower wavelengths observed.

The manufacture of fluorescing gold nano particles in aqueous solution occurs with gold tetrachloric acid HAuCl₄·H₂O as reactant, for example, in a 0.3 molar sodium hydroxide solution with a content of 0.3 mol/l mercaptoundecanoic acid. Depending on concentration ratio of gold tetrachloric acid to mercaptoundecanoic acid, gold nano particles fluorescing at different wavelengths can be manufactured. Gold tetrachloric acid is correspondingly added in a concentration dependent on the desired fluorescence wavelength. The forming of the gold nano particles begins, in such case, at a concentration ratio between gold tetrachloric acid and mercaptoundecanoic acid of greater than 0.01. The application of an additional reducing agent in the aqueous solution is not necessary.

As special example of an embodiment is described here for the manufacture of, for instance, a 1 ml solution of reddish fluorescing, gold nano particles. For this, 10 μl mercaptoundecanoic acid solution in 0.3 M sodium hydroxide solution is added to 1 ml 0.25 mM gold tetrachloric acid HAuCl₄·H₂O at room temperature. For an as complete as possible reaction yield, the solution is then, for instance, allowed to stand one day long. The formed gold nano particles can be centrifuged off as above described and then suspended in an aqueous solution of a saccharide functionalized dendrimer, for example, as above described, in an aqueous solution having a content of saccharide functionalized PPI dendrimer of fourth generation lying at 0.1 wt.-%. The ratio of the concentration of dendrimer to nano particles (in mol per liter) is selected in the range of 0.7 to 1.7.

The manufacture of composite structures 1, 1′ with a nano particle 2 and one or more nano particle 2 stabilizing, dendritic macromolecules 4 with functional groups, which comprise mono- or oligosaccharide units and which are so sealedly packed, that they form a saccharide cladding 5 around the dendritic macromolecule 4, can be performed in analogous manner, as here described on the basis of particular examples, for a large number of metal-, or metal oxide, nano particles and dendritic macromolecules with mono-, oligo- or polysaccharide groups. In such case, metal salts are applied as metal containing reactants. Suited as dispersion stabilizers are, basically, alkanethiols, for example, octadecanethiol or dodecanethiol, or thiophenols, as, for example, aminothio phenol or quite generally thiols, or mercaptanes and derivatives of these, for example, alkanethiols or thiophenols functionalized with acid groups.

This two stage synthesis process, in the case of which first the nano particles are synthesized and then stabilized by a saccharide functionalized, dendritic macromolecule, especially with transfer into an aqueous solution, and, for example, embedding in a cavity within the branched structure, permits a very precise adjusting of combinations of properties of the nano particles, or of the saccharide cladding of the composite structure. Thus, for example, in the case of fluorescing, nano particles, the fluorescence wavelength can be set in the first synthesizing step by choice of the dispersion stabilizer, the concentration ratios or other reaction conditions, while desired properties of the periphery of the composite structure, for example, a desired functionalizing, are set, as described below, independently therefrom and can be added first in the second synthesizing step of the composite structure.

The so obtained composite structures show a high stability also under extreme chemical conditions, for example, in solutions over a broad pH-value range between 1 and 13 and/or with high salt concentrations.

A further advantage of the here described composite structures is that the functional groups, which have a mono- or oligosaccharide unit, can be furnished with standard-methods of saccharide chemistry with a large number of functional groups. These functional groups can serve to attach the composite structure as marking to biomolecules in biological, biochemical or biophysical systems.

As an example, shown in FIG. 4 a) is fourth generation PPI dendrimer of FIG. 2 a), wherein the nitrogen atom of each terminal amine unit has two surface groups, which, in each case, comprise a functional group R. In the here illustrated example, the functional groups R are maltose groups. One of the maltose groups is furthermore functionalized with an acetic acid group (—CH2COOH) and forms so, as a whole, a moiety R1. The acetic acid group can serve as functional group for bonding a composite structure formed of one or more molecules of the saccharide functionalized dendrimer illustrated in FIG. 4 a) and a nano particle surrounded, in given cases, by a dispersion stabilizer cladding, to a biomolecule by means of a functional group of the biomolecule complementary to the acetic acid group.

Alternatively, functional groups for bonding to a biomolecule can also be placed directly on a terminal unit or linear unit of the dendritic macromolecule belonging to the periphery, for example, bonded to a nitrogen atom of a terminal unit of the PPI dendrimers illustrated in FIG. 2 a) or b), Shown in FIG. 4 b) is the PPI dendrimer of FIG. 2 a) with, in each case, two maltose-surface groups on each of the terminal units of the dendrimer, wherein on a nitrogen atom of an end group of the dendrimer, instead of a maltose group, an a-lipoic acid group is bonded. The a-lipoic acid group is bonded to the nitrogen atom 9 of a terminal amine unit of the dendrimer A. The a-lipoic acid group can serve for the bonding of a functional group of a biomolecule, e.g. a thiol group. Also a biomolecule, which originally has no thiol group, can be bonded to the composite structure of the present example functionalized with a-lipoic acid by functionalizing the biomolecule earlier with a thiol group.

The functionalizing of the dendritic macromolecule with such functional groups of second type, which are suitable for bonding the composite structure to a biomolecule, can occur according to the previously described manufacture of the composite structures of nano particles and saccharide functionalized, dendritic macromolecule, by bonding to at least one surface group or to at least one terminal unit of a dendritic macromolecule of the composite structures a functional group of second type. It is also possible, first to functionalize the saccharide functionalized, dendritic macromolecules correspondingly, before they are mixed with the nano particles for forming composite structures.

Application of the above described composite structures for the qualitative and/or quantitative detection of analytes in liquid- and solid phases, for example, in a biosensor, in an assay or for the investigation of transport phenomena in cells is performed by first marking with the composite structure biomolecules participating in the processes to be examined or a molecule bonding specifically to the analyte, the marked molecules are added to the sample to be measured or to be analyzed, and, using the luminescent- or magnetic properties of the composite structure, the amount of the molecules bonded to the analytes to be detected or the distribution of the marked molecules in the system to be examined is determined and evaluated. If the composite structure has, for example, luminescent properties, its application in biosensors, which are embodied according to established optical transduction principles, is an option, as, for example, in the case of the ELISA/EIA test or in the case of investigations of biological systems with the assistance of a fluorescence microscope. If the composite structure has magnetic properties, then it can be applied, for example, as a marker in a magnetic assay, e.g. MARIA.

1-18. (canceled)

19. A composite structure, comprising:
at least one nano particle and at least one dendritic macromolecule, which has an inner region with branched, especially perfectly branched to highly branched, structures and a periphery, which comprises surface groups of said dendritic macromolecule, wherein:
a plurality, especially more than 50%, of said surface groups in the periphery of said dendritic macromolecule have, in each case, at least one functional group of first type;
said functional group of first type comprises at least one monosaccharide-, oligosaccharide- and/or polysaccharide unit; and
said dendritic macromolecule stabilizes said nano particle.

20. The composite structure as claimed in claim 19, wherein:
said nano particle has fluorescing properties.

21. The composite structure as claimed in claim 20, wherein:
said nano particle comprises a metal particle, especially of a noble metal or a mixture of a plurality of noble metals, especially gold, silver or copper, a quantum dot, especially a semiconductor nano particle of a doped or not doped II-VI- or II-V semiconductor, or a nano diamond.

22. The composite structure as claimed in claim 19, wherein:
said nano particle has magnetic properties.

23. The composite structure as claimed in claim 22, wherein:
said nano particle is a metal particle of one or a mixture of a plurality of the metals, iron, cobalt, nickel, or a metal oxide particle, especially of a metal oxide selected from the group formed of iron oxide, barium ferrite, strontium ferrite and chromium dioxide, or an iron oxide particle containing manganese-, copper-, nickel- or cobalt.

24. The composite structure as claimed in claim 19, wherein:
said nano particle has along its longest axis at least one diameter of 0.5 to 20 nm, especially a diameter between 0.5 and 2 nm.

25. The composite structure as claimed in claim 19, wherein:
said nano particle has on its surface a plurality of molecules of a dispersion stabilizer bonded to the surface; and
said dispersion stabilizer is especially octadecanethiol, aminothio phenol or mercaptoundecanoic acid or a derivative of octadecanethiol, aminothio phenol or mercaptoundecanoic acid.

26. The composite structure as claimed in claim 19, wherein:
said dendritic macromolecule comprises a dendrimer, especially one of third to tenth generation, which is selected from the group consisting of polypropylene imines, polyamidoamines and polyether imines and their derivatives.

27. The composite structure (1, 1′) as claimed in claim 19, wherein:
said dendritic macromolecule comprises a highly branched polymer preferably having an average molecular weight of less than 10,000 g/mol, which is selected from the group preferably consisting of highly branched poly(ethylene imines), highly branched polyglycerols, highly branched polyamides, highly branched polylysines, highly branched polyesters and their derivatives.

28. The composite structure as claimed in claim 19, wherein:
said at least one functional group of first type is a monosaccharide group, a linear or branched, oligosaccharide group, a linear or branched, polysaccharide group, a group formed of a derivative of a monosaccharide, a group formed of a derivative of a linear or branched oligosaccharide or a group formed of a derivative of a linear or branched polysaccharide.

29. The composite structure as claimed in claim 28, wherein:
said at least one functional group of first type is selected from the group preferably consisting of glucose, fructose, galactose, maltose, lactose, cellobiose, mannose, dimannose, melobiose, maltotriose and maltoheptose and derivatives of these.

30. The composite structure as claimed in claim 19, wherein:
said dendritic macromolecule is a dendrimer; and
a plurality, especially more than 50%, of terminal units present in the periphery of the dendrimer comprise one, two or more functional groups of first type (R).

31. The composite structure as claimed in claim 19, wherein:
said nano particle is accommodated in the inner region of the dendritic macromolecule.

32. The composite structure as claimed in claim 19, wherein:
at least two dendritic macromolecules adjoin with their periphery to said nano particle and stabilize such.

33. The composite structure as claimed in claim 19, wherein:
said at least one surface group of said dendritic macromolecule and/or at least one functional group of first type comprised of a surface group of said dendritic macromolecule has a functional group of second type, which is especially suited to react with an additional functional group of third type of an additional molecule, especially a biomolecule, a ligand/receptor, a bioactive molecule, a bioactive macromolecule, a biological ligand/receptor or a biological recognition sequence, especially an oligo- and polynucleotide or a peptide recognition sequence.

34. The composite structure as claimed in claim 33, wherein:
the functional group of second type of the dendritic macromolecule is an amino group, acid group, epoxide group, azide group, alkyne group, alkylene group, activated ester group, aldehyde group, amide derivative group, sulfonic acid amide derivative group, sulfate group, sulfonate group, halogen group, activated ether group or thiol group;
the functional group of second type of the functional group of first type is a hydroxy group, an amino group, an acid group, epoxide group, azide group, alkyne group, alkylene group, activated ester group, aldehyde group, amide derivative group, sulfonic acid amide derivative group, sulfate group, sulfonate group, halogen group, activated ether group and/or thiol group; and
the further functional group of third type is an amino group, acid group, epoxide group, azide group, alkyne group, alkylene group, activated ester group, aldehyde group, amide derivative group, sulfonic acid amide derivative group, sulfate group, sulfonate group, halogen group, activated ether group or thiol group.

35. A method for manufacture of a composite structure as claimed in claim 19, comprising the steps of:
stabilizing nano particles with a dispersion stabilizer, especially nano particles having a length along a longest axis of 0.5 to 2 nm, especially between 0.8 and 1.5 nm, are dispersed in an aqueous solution of dendritic macromolecules, which have an inner region with branched, especially perfectly branched to highly branched, structures, and a periphery, which comprises surface groups of the dendritic macromolecules, wherein:
a plurality of the surface groups of the dendritic macromolecules, in each case, have at least one functional group of first type; and the functional group of first type comprises at least one mono-, oligo- or polysaccharide unit.

36. The use of a composite structure as claimed in claim 19 for marking biomolecules in a biological, biochemical or medicinal system, especially in a biosensor, an optical or magnetic assay, especially in a competitive assay.
